(19) United States
(12) Patent Application Publication
(10) Pub. No.: US 2022/0327611 A1
(43) Pub. Date: Oct. 13, 2022

(54) INFORMATION PROCESSING APPARATUS, A METHOD, AND A NONVOLATILE STORAGE MEDIUM

(71) Applicant: CAMELOVE INC., Tokyo (JP)

(72) Inventor: Isao TAKASAKA, Tokyo (JP)

(73) Assignee: CAMELOVE INC., Tokyo (JP)

(21) Appl. No.: 17/847,443

(22) Filed: Jun. 23, 2022

Related U.S. Application Data
(63) Continuation of application No. PCT/JP2020/037269, filed on Sep. 30, 2020.

(30) Foreign Application Priority Data
Dec. 26, 2019 (JP) 2019-237332

(51) Int. Cl. G06Q 30/06

(52) U.S. Cl. CPC G06Q 30/0645; G06Q 30/0603

(57) ABSTRACT

A server 20 of a rental service system 1 includes a control unit 203 and a storage unit 202. The storage unit 202 stores information related to commodities that are rentable in a rental service in a rental commodity database 282. As functions thereof, the control unit 203 generates a link (first information) to a screen for applying for the rental service, causes a screen for accepting an instruction (a first instruction) for making a rental application for a commodity for rent to be displayed, purchases the commodity from an EC site provided by an external server, and manages the commodity as a rental object of the rental service.

### CROSS-REFERENCE TO RELATED APPLICATIONS

This application is a Continuation Application of No. PCT/JP2020/037269, filed on Sep. 30, 2020, and the PCT application is based upon and claims the benefit of priority from Japanese Patent Application No. 2019-237332, filed on Dec. 26, 2019, the entire contents of which are incorporated herein by reference.

### FIELD

Embodiments described herein relate generally to an information processing apparatus, a method, and a nonvolatile storage medium.

### BACKGROUND

Conventionally, there have been rental services that rent out a commodity on a temporary basis. Rental services are used when there is a need to use the commodity on a temporary basis instead of on a constant basis. For example, when one does not usually drive an automobile but wishes to use one on a temporary basis when moving, it is common practice to rent an automobile using a car rental that is a rental service of automobiles.

A rental product provider informs a user who desires to use a rental product by listing information on rental products to be provided by the provider on the provider's own website, a mall-like EC site, or the like. However, since a user can only select rental products listed on a website of each rental product provider, the need to refer to the websites of various rental product providers may become a hassle. As a technique for addressing such a situation, Patent Literature 1 discloses a technique related to an affiliate system made up of a rental product provider, a manager who posts an advertisement for soliciting rental applications, and a user who desires to use a rental product.

### BRIEF DESCRIPTION OF DRAWINGS

FIG. 1 is a diagram showing an overall configuration of a rental service system 1.

FIG. 2 is a block diagram showing a functional configuration of a terminal apparatus 10 constituting the rental service system 1 according to a first embodiment.

FIG. 3 is a diagram showing a functional configuration of a server 20 constituting the rental service system 1 according to the first embodiment.

FIG. 4 is a diagram showing data structures of a user database 281, a rental commodity database 282, and a rental commodity inventory database 283 stored in the server 20.

FIG. 5 is a flow chart showing an example of a flow in which registration acceptance processing of a commodity for rent is performed by the rental service system 1 according to the first embodiment.

FIG. 6 is a flow chart showing an example of a flow in which rental acceptance processing of a commodity for rent is performed by the rental service system 1 according to the first embodiment.

FIG. 7 is a diagram showing a screen example of the terminal apparatus 10 in the rental acceptance processing of a commodity for rent.

FIG. 8 is a diagram showing a screen example of the terminal apparatus 10 in the rental acceptance processing of a commodity for rent.

FIG. 9 is a diagram showing another screen example of the terminal apparatus 10 in the rental acceptance processing of a commodity for rent.

FIG. 10 is a diagram showing another screen example of the terminal apparatus 10 in the rental acceptance processing of a commodity for rent.

FIG. 11 is a diagram showing a functional configuration of the server 20 constituting the rental service system 1 according to a second embodiment.

FIG. 12 is a diagram showing a functional configuration of the server 20 constituting the rental service system 1 according to a third embodiment.

### DETAILED DESCRIPTION

In general, according to one embodiment of the present disclosure, an information processing apparatus which includes a processing circuitry and a storage unit provides a user with a rental service of commodities. The storage unit is configured to store information for specifying each commodity, and the processing circuitry performs: a step of generating first information for accepting, from a user, an instruction of a rental application for a commodity for rent on an external website; a step of causing, in response to an access from a terminal of the user to the external website, the terminal of the user to display a screen for accepting a first instruction to perform a rental application for the commodity for rent based on the first information; a step of performing, in response to accepting the first instruction from the user, processing for purchasing a commodity related to the first instruction; and a step of performing processing for managing the purchased commodity as a rental object of the rental service.

Hereinafter, embodiments of the present disclosure will be described with reference to the drawings. In the following description, the same components are assigned the same reference signs. In addition, names and functions of such components are also the same. Therefore, detailed descriptions of such components will not be repeated.

Hereinafter, a rental service will be described. For example, the rental service is a service that rents commodities such as electric home appliances, clothing, and bags for a certain period of time. A user can use the commodity rental service by signing up as a member on a server providing the rental service and accessing the server. As commodities that can be rented with the rental service, commodities of different manufacturers or brands, performance, or ranks are prepared in a plurality of types and the user can use such commodities by applying for rental according to his or her preference.

In addition, the commodities that can be rented with the rental service can also be purchased from other dealers. A rental business operator who operates the rental service purchases commodities from the other dealers and rents the purchased commodities to users of the rental service. In doing so, since a fee for using the rental service is usually set lower than a price of purchase from the dealers, a user can use the commodities less expensively than purchasing from the other dealers. In addition, once the rental business operator purchases commodities from the other dealers, the rental business operator manages the commodities as an inventory of rentable commodities and rents the commodities to users of the rental service. Therefore, the rental business operator makes a profit by predicting how much (a period or the number of times) the commodities are to be rented and setting the rental fee such that a total amount of the rental fees is higher than the purchase prices (including costs such as the rental business operator's own management cost) from the other dealers.

Furthermore, on an EC site operated by another dealer, a page that lists commodities being sold by the dealer also enables a commodity to be rented with the rental business operator described earlier. For example, on the EC site operated by the dealer, the page that lists commodities being sold by the dealer enables an application for renting a commodity from the rental business operator to be made. Specifically, the page that lists commodities of the dealer is provided with a link for making a transition to an application screen for renting from the rental business operator. In doing so, a price in a case where the commodity is purchased and a fee in a case where the commodity is rented are displayed so that both cases can be considered. Accordingly, the fact that the rental business operator purchases a commodity even when a user makes a rental application for the commodity is also advantageous to the dealer, and the fact that the rental business operator need not manage an inventory until the commodity is purchased is advantageous to the rental business operator.

In the following embodiment, a service that rents commodities such as a camera, an interchangeable lens, and electric home appliances will be described as an example of a rental service.

### First Embodiment

Hereinafter, a rental service system 1 that rents commodities such as a camera, an interchangeable lens, and electric home appliances will be described. In the following description, for example, in response to a terminal apparatus 10 accessing a server 20 or an external server 30, the server 20 or the external server 30 returns information for generating a screen on the terminal apparatus 10. The terminal apparatus 10 generates and displays a screen based on the information received from the server 20 or the external server 30.

<1 Overall Configuration of Rental Service System 1>

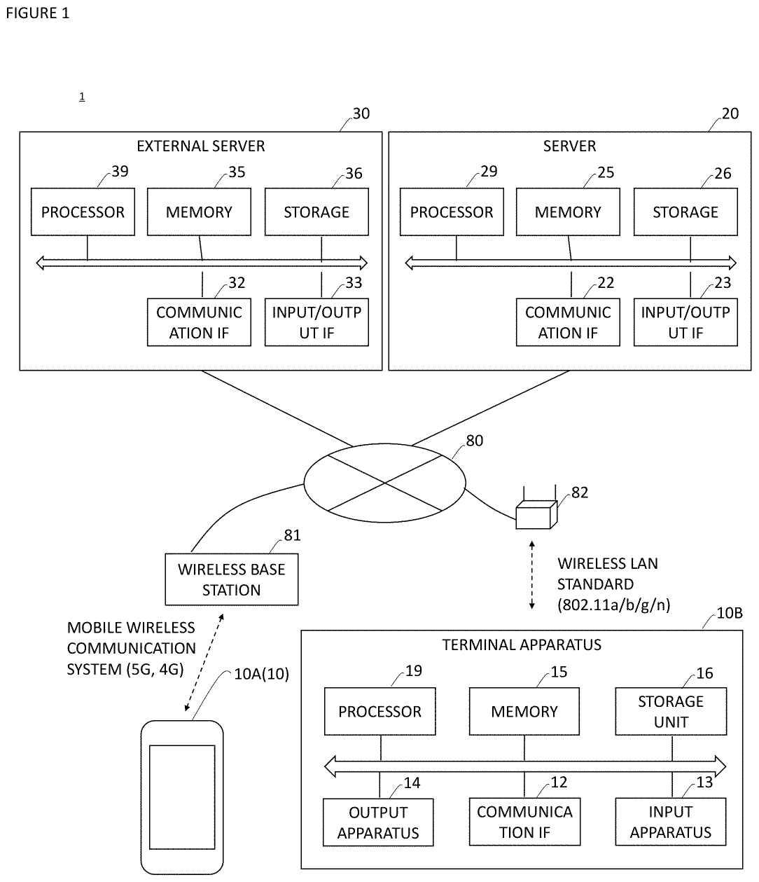

FIG. 1 is a diagram showing an overall configuration of the rental service system 1. The rental service system is a system for renting commodities such as a camera, an interchangeable lens, and electric home appliances. As shown in FIG. 1, the rental service system 1 includes a plurality of terminal apparatuses (a terminal apparatus 10A and a terminal apparatus 10B are shown in FIG. 1; hereinafter, also sometimes collectively referred to as a “terminal apparatus 10”), the server 20, and the external server 30. The terminal apparatuses 10, the server 20, and the external server 30 are connected to each other by a network 80 so that they can communicate with each other. The network 80 is constituted of a wired or wireless network.

The terminal apparatus 10 is an apparatus operated by each user. The terminal apparatus 10 is realized by a mobile terminal such as a smartphone or a tablet that supports a mobile communication system. Otherwise, for example, the terminal apparatus 10 may be a stationary PC (Personal Computer) or a laptop PC. As shown in FIG. 1 as the terminal apparatus 10B, the terminal apparatus 10 includes a communication IF (Interface) 12, an input apparatus 13, an output apparatus 14, a memory 15, a storage unit 16, and a processor 19.

The terminal apparatus 10 is connected to the server 20 via the network 80 so that they can communicate with each other. The terminal apparatus 10 is connected to the network 80 by communicating with a communication device such as a wireless base station 81 that supports a communication standard such as 5G or LTE (Long Term Evolution) or a wireless LAN (Local Area Network) router 82 that supports a wireless LAN standard such as IEEE (Institute of Electrical and Electronics Engineers) 802.11.

The communication IF 12 is an interface used by the terminal apparatus 10 to input and output signals in order to communicate with an external apparatus. The input apparatus 13 is an input apparatus (for example, a touch panel, a touch pad, a pointing device such as a mouse, or a keyboard) for accepting an input operation from a user. The output apparatus 14 is an output apparatus (a display, a speaker, or the like) for presenting the user with information. The memory 15 is for temporarily storing programs and data or the like to be processed by the programs or the like and is, for example, a volatile memory such as a DRAM (Dynamic Random Access Memory). The storage unit 16 is a storage apparatus for storing data and is, for example, a flash memory or an HDD (Hard Disc Drive). The processor 19 is hardware for executing instruction sets described in a program and is constituted of an arithmetic unit, a register, a peripheral circuit, and the like.

The server 20 is an apparatus used by the rental business operator to manage information on each user of the rental service provided by the rental service system 1, information on rentable commodities, and information on an inventory status of the rentable commodities. The server 20 accepts a rental application from a user via the external server 30.

In addition, when a commodity for which a rental application is made is out of stock, the server 20 applies to the external server 30 for a purchase of the commodity. When the server 20 accepts a rental application from the user and the commodity is in stock or the server 20 has purchased the commodity from the external server 30, the server 20 performs shipment processing of the commodity.

The server 20 is a computer connected to the network 80. The server 20 includes a communication IF 22, an input/output IF 23, a memory 25, a storage 26, and a processor 29.

The communication IF 22 is an interface used by the server 20 to input and output signals in order to communicate with an external apparatus. The input/output IF 23 functions as an interface with an input apparatus for accepting an input operation from a rental business operator and with an output apparatus for presenting a user with information. The memory 25 is for temporarily storing programs and data or the like to be processed by the programs or the like and is, for example, a volatile memory such as a DRAM (Dynamic Random Access Memory). The storage 26 is a storage apparatus for storing data and is, for example, a flash memory or an HDD (Hard Disc Drive). The processor 29 is hardware for executing instruction sets described in a program and is constituted of an arithmetic unit, a register, a peripheral circuit, and the like.

The external server 30 is an apparatus used by a dealer to manage information on each user of an EC side (an external website), information on sellable commodities, and information on an inventory status of the sellable commodities. The external server 30 presents a user with a sellable and rentable commodity and accepts an application for sales or rental from the user. When a rental application for a commodity is made, the external server 30 issues an instruction for the rental application to the server 20.

The external server 30 is a computer connected to the network 80. The external server 30 includes a communication IF 32, an input/output IF 33, a memory 35, a storage 36, and a processor 39.

The communication IF 32 is an interface used by the external server 30 to input and output signals in order to communicate with an external apparatus. The input/output IF 33 functions as an interface with an input apparatus for accepting an input operation from a user and with an output apparatus for presenting the user with information. The memory 35 is for temporarily storing programs and data or the like to be processed by the programs or the like and is, for example, a volatile memory such as a DRAM (Dynamic Random Access Memory). The storage 36 is a storage apparatus for storing data and is, for example, a flash memory or an HDD (Hard Disc Drive). The processor 39 is hardware for executing instruction sets described in a program and is constituted of an arithmetic unit, a register, a peripheral circuit, and the like.

<1.1 Configuration of Terminal Apparatus 10>

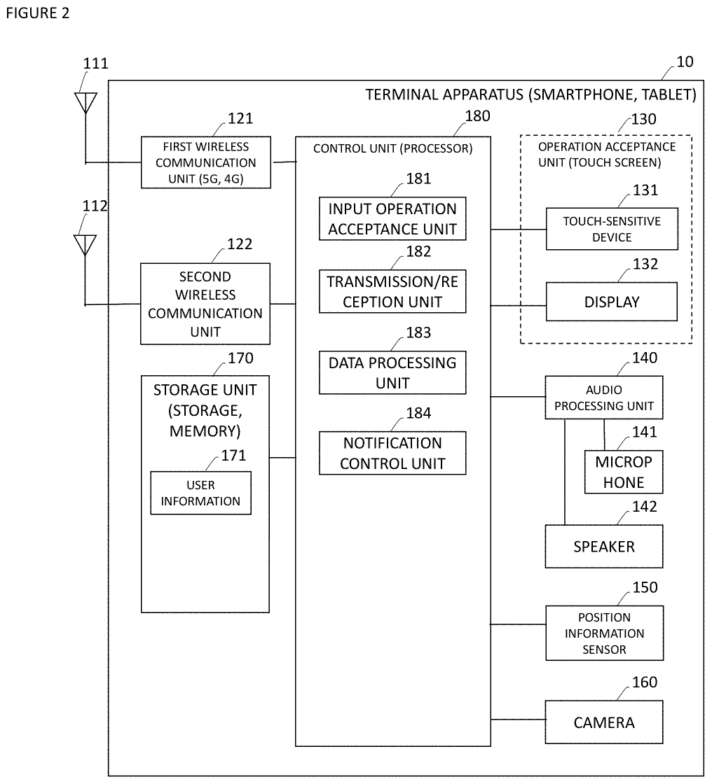

FIG. 2 is a block diagram of the terminal apparatus 10 constituting the rental service system 1 according to the first embodiment. As shown in FIG. 2, the terminal apparatus 10 includes a plurality of antennas (an antenna 111 and an antenna 112), a wireless communication unit corresponding to each antenna (a first wireless communication unit 121 and a second wireless communication unit 122), an operation acceptance unit 130 (including a touch-sensitive device 131 and a display 132), an audio processing unit 140, a microphone 141, a speaker 142, a position information sensor 150, a camera 160, a storage unit 170, and a control unit 180. The terminal apparatus 10 also has functions and components not particularly illustrated in FIG. 2 (for example, a battery for holding power and a power supply circuit for controlling supply of power from the battery to each circuit). As shown in FIG. 2, each block included in the terminal apparatus 10 is electrically connected by a bus or the like.

The antenna 111 radiates, as a radio wave, a signal emitted by the terminal apparatus 10. In addition, the antenna 111 receives a radio wave from space and provides the first wireless communication unit 121 with a reception signal.

The antenna 112 radiates, as a radio wave, a signal emitted by the terminal apparatus 10. In addition, the antenna 112 receives a radio wave from space and provides the second wireless communication unit 122 with a reception signal.

The first wireless communication unit 121 performs modulation/demodulation processing or the like for transmitting and receiving signals via the antenna 111 to enable the terminal apparatus 10 to communicate with another wireless device. The second wireless communication unit 122 performs modulation/demodulation processing or the like for transmitting and receiving signals via the antenna 112 to enable the terminal apparatus 10 to communicate with another wireless device. The first wireless communication unit 121 and the second wireless communication unit 122 are communication modules that include a tuner, an RSSI (Received Signal Strength Indicator) calculation circuit, a CRC (Cyclic Redundancy Check) calculation circuit, and a high frequency circuit. The first wireless communication unit 121 and the second wireless communication unit 122 perform modulation/demodulation and frequency conversion of radio signals transmitted and received by the terminal apparatus 10 and provide the control unit 180 with a reception signal.

The operation acceptance unit 130 has a mechanism for accepting an input operation by a user. Specifically, the operation acceptance unit 130 is configured as a touch screen and includes the touch-sensitive device 131 and the display 132.

The touch-sensitive device 131 accepts an input operation by the user of the terminal apparatus 10. By using, for example, a capacitance-type touch panel, the touch-sensitive device 131 detects a contact position of the user with respect to the touch panel. The touch-sensitive device 131 outputs a signal indicating the contact position of the user detected by the touch panel to the control unit 180 as an input operation.

The display 132 displays data such as an image, a moving image, or a text in accordance with control by the control unit 180. The display 132 is realized by, for example, an LCD (Liquid Crystal Display) or an organic EL (Electro-Luminescence) display.

The audio processing unit 140 performs modulation/demodulation of an audio signal. The audio processing unit 140 modulates a signal provided by the microphone 141 and provides the control unit 180 with the modulated signal. In addition, the audio processing unit 140 provides the speaker 142 with an audio signal. The audio processing unit 140 is realized by, for example, a processor for audio processing. The microphone 141 accepts an audio input and provides the audio processing unit 140 with an audio signal corresponding to the audio input. The speaker 142 converts the audio signal provided by the audio processing unit 140 into audio and outputs the audio to outside of the terminal apparatus 10.

The position information sensor 150 is a sensor that detects a position of the terminal apparatus 10 and is, for example, a GPS (Global Positioning System) module. The GPS module is a reception apparatus used in a satellite positioning system. In the satellite positioning system, signals from at least three or four satellites are received and a present position of the terminal apparatus 10 mounted with the GPS module is detected based on the received signals.

The camera 160 is a device for receiving light using a light-receiving element and outputting the light as a photographed image. The camera 160 is, for example, a depth camera capable of detecting a distance from the camera 160 to a photographed object.

The storage unit 170 is constituted of, for example, a flash memory and stores data and programs used by the terminal apparatus 10. In a certain aspect, the storage unit 170 stores user information 171.

The user information 171 is information on a user who uses the terminal apparatus 10 to use the rental service. User information includes information that identifies the user (a user ID), a name of the user, attribute information of the user, and information on a commodity for which the user had used rental (a commodity ID that identifies the commodity).

The control unit 180 controls operations of the terminal apparatus 10 by reading a program stored in the storage unit 170 and executing instructions included in the program. For example, the control unit 180 is an application installed in the terminal apparatus 10 in advance. By operating in accordance with the program, the control unit 180 exhibits functions as an input operation acceptance unit 181, a transmission/reception unit 182, a data processing unit 183, and a notification control unit 184.

The input operation acceptance unit 181 performs processing of accepting an input operation by the user with respect to an input apparatus such as the touch-sensitive device 131. Based on information on coordinates where the user had brought a finger or the like into contact with the touch-sensitive device 131, the input operation acceptance unit 181 determines a type of the operation by the user such as whether the operation is a flick operation, a tap operation, a drag (swipe) operation, or the like.

The transmission/reception unit 182 performs processing to enable the terminal apparatus 10 to transmit and receive data according to a communication protocol to and from an external apparatus such as the server 20.

The data processing unit 183 performs, with respect to data of which input has been accepted by the terminal apparatus 10, processing of performing an arithmetic operation according to a program and outputting an operation result to a memory or the like.

The notification control unit 184 performs processing of presenting the user with information. The notification control unit 184 performs processing of causing a display image to be displayed on the display 132, processing of causing audio to be output from the speaker 142, processing of causing the camera 160 to generate vibration, and the like.

<1.2 Functional Configuration of Server 20>

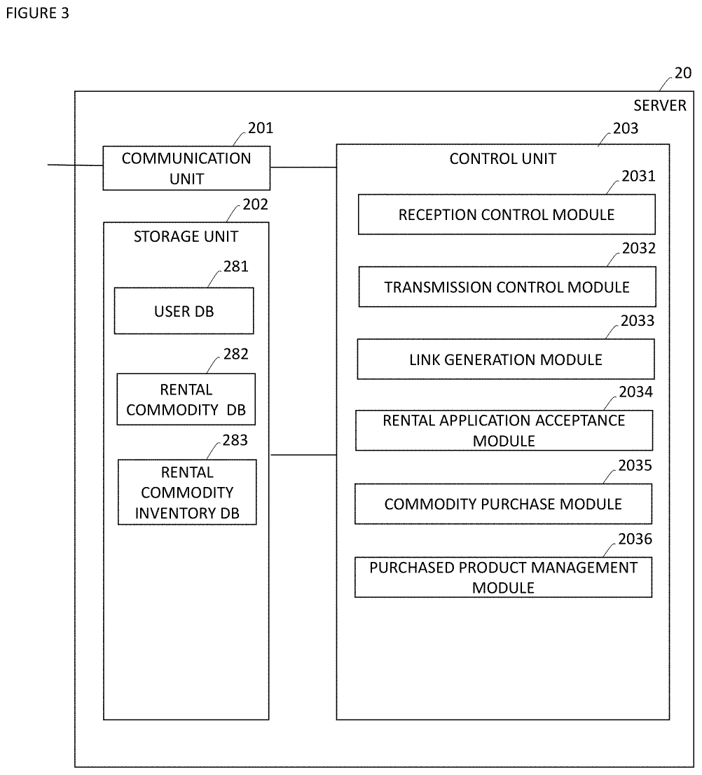

FIG. 3 is a diagram showing a functional configuration of the server 20 constituting the rental service system 1 according to the first embodiment. As shown in FIG. 3, the server 20 exhibits functions as a communication unit 201, a storage unit 202, and a control unit 203.

The communication unit 201 performs processing to enable the server 20 to communicate with an external apparatus.

The storage unit 202 stores data and programs used by the server 20. The storage unit 202 stores a user database 281, a rental commodity database 282, a rental commodity inventory database 283, and the like.

The user database 281 is a database for holding information on each user in the rental service system 1. Details will be provided later.

The rental commodity database 282 is a database for holding information related to commodities that are rentable in the rental service provided by the rental service system 1. Details will be provided later.

The rental commodity inventory database 283 is a database for holding information related to an inventory of the commodities that are rentable in the rental service provided by the rental service system 1. Details will be provided later.

The control unit 203 exhibits functions presented as various modules when the processor of the server 20 performs processing according to a program.

A reception control module 2031 controls processing by the server 20 of receiving a signal from an external apparatus according to a communication protocol.

A transmission control module 2032 controls processing by the server 20 of transmitting a signal to an external apparatus according to a communication protocol.

A link generation module 2033 controls processing of generating first information for accepting, from a user, an instruction of a rental application for a commodity for rent that is provided by the rental service system 1. Specifically, the link generation module 2033 controls processing of generating a link (first information) to a screen for applying for the rental service. The screen for applying for the rental service is, for example, a web page provided by the server 20. In other words, the link generation module 2033 generates a link for making a transition from an EC site provided by the external server 30 to a web page which is provided by the server 20 and which lists the commodity. Information on the generated link is transmitted to the external server 30 and presented on an EC site provided by the external server 30. In addition, the information on the generated link is stored as information related to the commodity in the rental commodity database 282.

A rental application acceptance module 2034 controls, in response to an access to the link presented on an EC site provided by the external server 30, processing of causing the terminal apparatus 10 to display a screen for accepting an instruction (a first instruction) for making a rental application for a commodity for rent. The screen to be displayed at this point is the screen that is a destination of the link described above. Examples of means for accepting an instruction for making a rental application include a link or a button of a rental application displayed on a web page provided by the server 20. In other words, when a link or a button for a rental application is depressed, the rental application acceptance module 2034 accepts an instruction thereof. In doing so, the rental application acceptance module 2034 may accept information on a user and information on an expected return date or the like of the commodity to be rented in addition to the instruction for making a rental application. In addition, the information on the rental application is stored as information related to a rental history in the user database 281.

A commodity purchase module 2035 controls, in response to accepting an instruction to make a rental application for a commodity for rent, processing of purchasing the commodity from an EC site provided by the external server 30 when the commodity is not included in an inventory of commodities managed by the rental business operator. The commodity purchase module 2035 refers to the rental commodity inventory database 283, and in a case where a commodity related to the accepted instruction for a rental application is not in stock, the commodity purchase module 2035 performs processing of purchasing the commodity from the EC site provided by the external server 30. Note that a case where the commodity is not in stock may include a case where the commodity is yet to be purchased from the EC site provided by the external server 30 and a case where the commodity had been purchased but is being rented by another user and is currently in use.

A purchased product management module 2036 controls processing of managing, as a rental object of the rental service, a commodity purchased from the EC site provided by the external server 30. The commodity purchased from the EC site may include a case where the rental business operator manages inventory at its own facility or the like and a case where the rental business operator commissions management of the commodity to another person (another company) and manages a state thereof. Management information of the purchased commodity is managed by being stored in the rental commodity inventory database 283.

<2 Data Structure>

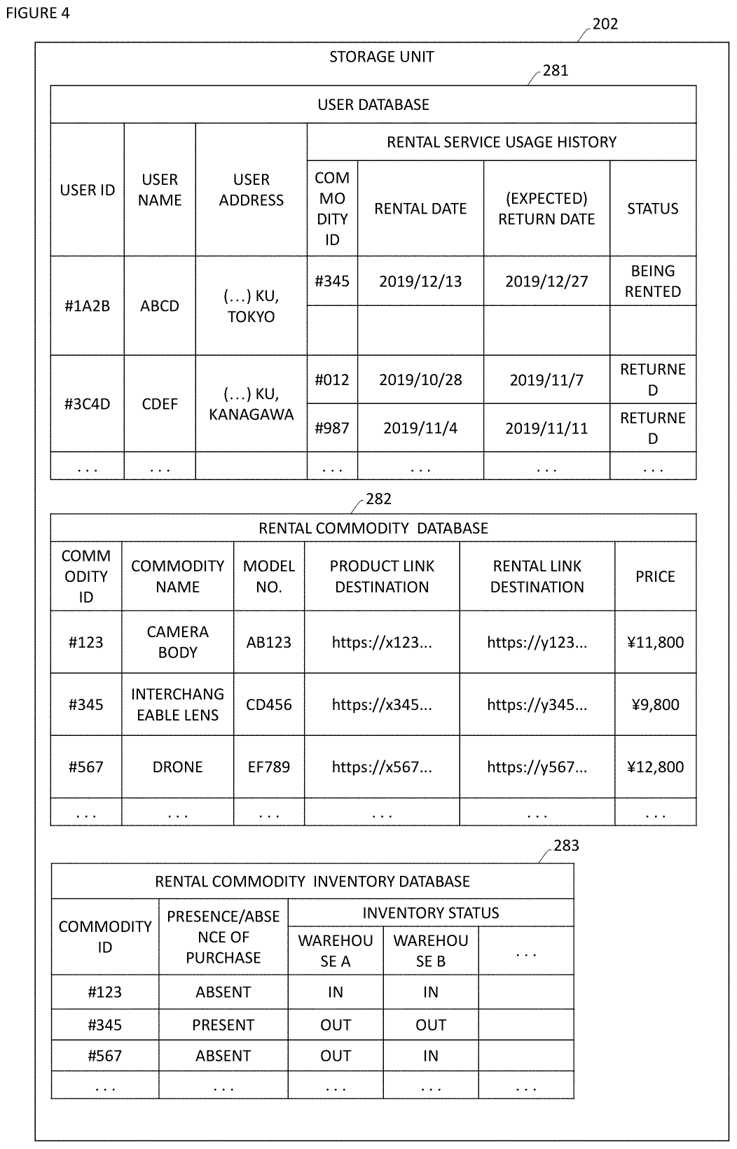

FIG. 4 is a diagram showing data structures of the user database 281, the rental commodity database 282, and the rental commodity inventory database 283 stored in the server 20.

As shown in FIG. 4, each record of the user database 281 includes an item “user ID”, an item “user name”, an item “user address”, and an item “rental service usage history”.

The item “user ID” is information that identifies each user registered as a member in the rental service system 1.

The item “user name” is a name set by the user and is usually the name of the user in full.

The item “user address” is an address set by a user, and while the “user address” is usually the address of the user's residence, an address to which the user instructing rental of a commodity desires the commodity to be sent may suffice such as an address of a workplace.

The item “rental service usage history” is information related to a history of use of a rental service of commodities by each user and, specifically, the item “rental service usage history” includes an item “commodity ID”, an item “rental date”, an item “(expected) return date”, and an item “status”. Note that information related to history includes information on a commodity for which the rental service is in use (being rented) and information on a commodity already used (returned).

The item “commodity ID” is information that identifies a commodity to be a rental object in the rental service system 1.

The item “rental date” is information indicating a date on which a commodity had been rented out to a user in a rental service of the commodity. The date on which a commodity had been rented out may be a date on which an application for the rental service had been made by the user, a date on which the commodity had been shipped to the user, or a date on which the user had received the commodity.

The item “(expected) return date” is information indicating an expected return date in a case where the rental service of a commodity is in use or a return date in a case where the commodity has already been returned and already been used. The expected return date may be a date of acceptance from the user or a date designated by the rental application acceptance module 2034.

The item “status” is information indicating a usage situation of the rental service of a commodity. Specifically, the “status” is “being rented” when the rental service is in use and the “status” is “returned” when the rental service has already been used.

The server 20 updates the user database 281 when accepting a membership registration from each user and accepting the rental service of a commodity.

Each record of the rental commodity database 282 includes an item “commodity ID”, an item “commodity name”, an item “model number”, an item “product link destination”, an item “rental link destination”, and an item “fee”.

The item “commodity ID” is information that identifies a commodity to be a rental object in the rental service system 1 and corresponds to the item “commodity ID” of the user database 281.

The item “commodity name” is information that indicates a name of a commodity to be a rental object in the rental service system 1. The name of a commodity may be a common name of the commodity and may include a model name or a brand name

The item “model number” is information that indicates a model number of a commodity to be a rental object in the rental service system 1. The item “model number” is used when a commodity cannot be identified by the name in the item “commodity name” alone and identification according to the model number is required.

The item “product link destination” is a link (URL) to a web page on which the commodity is listed in the EC site provided by the external server 30. Specifically, the item “product link destination” is a link to a web page on which a link to a screen for applying for the rental service is set. The link may be a web page on which the commodity is displayed as a list together with other commodities or a web page on which only the commodity is displayed.

The item “rental link destination” is a link (URL) to a web page that is an application page for applying for rental of the commodity among web pages provided by the server 20. The link may be a web page on which the commodity is displayed as a list together with other commodities or a web page on which only the commodity is displayed.

The item “fee” is information indicating a fee in a case where the commodity is rented.

The server 20 updates the rental commodity database 282 when accepting an information registration of a commodity for rent from the rental business operator and accepting link information from the external server 30.

Each record of the rental commodity inventory database 283 includes an item “commodity ID”, an item “presence/absence of purchase”, and an item “inventory status”.

The item “commodity ID” is information that identifies a commodity to be a rental object in the rental service system 1 and corresponds to the item “commodity ID” of the user database 281 and the rental commodity database 282.

The item “presence/absence of purchase” is information indicating whether or not the commodity for rent has already been purchased from an EC site provided by the external server 30. For example, as shown in FIG. 4, “PRESENT” indicating that the commodity has already been purchased or “ABSENT” indicating that the commodity is yet to be purchased is stored.

The item “inventory status” is information indicating an inventory status of the commodity. For example, as shown in FIG. 4, for each warehouse or the like managed by the rental business operator, “IN” indicating that the commodity is in stock or “OUT” indicating that the commodity is out of stock is stored.

The server 20 updates the rental commodity inventory database 283 when accepting an information registration of a commodity for rent from the rental business operator and accepting information on the inventory status of the commodity.

<3 Operations>

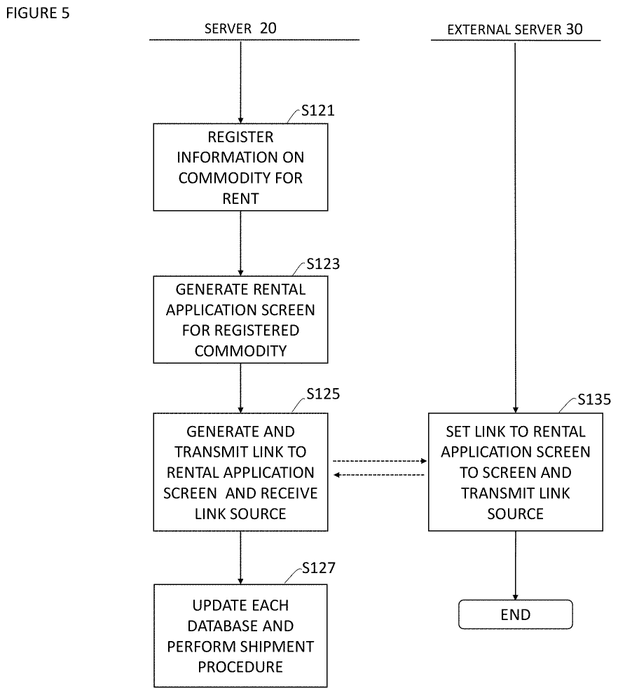

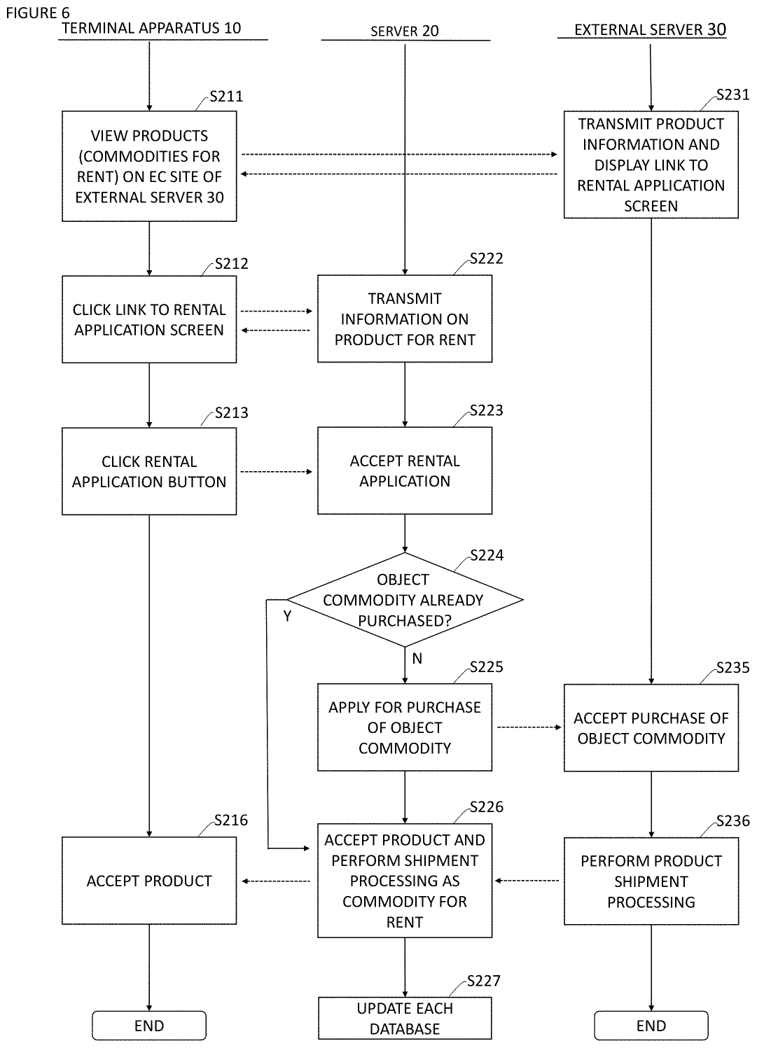

Hereinafter, with reference to FIGS. 5 and 6, registration acceptance processing of a commodity for rent and rental acceptance processing of the commodity for rent by the rental service system 1 according to the first embodiment will be described.

FIG. 5 is a flow chart showing an example of a flow in which registration acceptance processing of a commodity for rent is performed by the rental service system 1 according to the first embodiment.

In step S121, the input/output IF 23 of the server 20 accepts an operation for performing a registration to make a commodity a rentable object in the rental service system 1 from a rental business operator. The rental business operator inputs information such as a name and a model number of the commodity to be made rentable from the input/output IF 23 of the server 20. The server 20 stores the accepted information on the commodity in the rental commodity database 282.

In step S123, from the accepted information such as the name and the model number of the commodity to be made rentable, the server 20 generates a screen for accepting an instruction to make a rental application for the commodity. Specifically, an application screen is generated by causing information on the commodity (including information such as a picture obtained by photographing an exterior of the commodity) to be displayed on a web page provided by the server 20 and arranging a rental application button for performing an instruction for a rental application.

In step S125, the link generation module 2033 of the server 20 generates a link with respect to the generated screen for accepting an instruction to make a rental application for the commodity. Specifically, a directory name of the screen for accepting an instruction to make a rental application for the commodity is assigned to a URL of a web page provided by the server 20. The server 20 transmits information on the generated link to the external server 30 via the communication unit 201. In addition, the server 20 accepts, from the external server 30 via the communication unit 201, information on a link of an EC site provided by the external server 30 to which the generated link is set.

In step S135, the external server 30 sets the accepted link of the screen for accepting an instruction to make a rental application for the commodity to the EC site provided by the external server 30. The external server 30 transmits, to the server 20, information on the link of the EC site provided by the external server 30 to which the accepted link is set.

In step S127, the server 20 performs registration of the commodity for rent by storing, in the rental commodity database 282, information on the accepted link of the EC site provided by the external server 30.

As described above, a link to the rental application screen of a commodity for rent of the rental service system 1 is set to an EC site provided by the external server 30. Accordingly, both cases of purchasing and renting the commodity can be considered.

FIG. 6 is a flow chart showing an example of a flow in which rental acceptance processing of a commodity for rent is performed by the rental service system 1 according to the first embodiment.

In step S211, the input operation acceptance unit 181 of the terminal apparatus 10 accepts, from a user, an operation for presenting a list of rentable commodities in order to use a rental service of the rental service system 1. For example, the user refers to an EC site which is operated by a dealer and which is provided by the external server 30, refers to a commodity, and performs an operation for causing a list of commodities to be presented in order to consider whether to purchase or rent the commodity. The transmission/reception unit 182 of the terminal apparatus 10 accepts information on the list of commodities transmitted from the external server 30. The notification control unit 184 causes the display 132 to display the accepted information on the list of commodities.

In step S231, the external server 30 accepts a request for causing the list of commodities having been transmitted from the terminal apparatus 10 to be presented. In response to the request from the terminal apparatus 10, the external server 30 transmits the information on the list of commodities to the terminal apparatus 10 in order to present the list of commodities. For example, the list of commodities transmitted by the external server 30 provides a purchase procedure transition button for making a transition to a screen for purchasing each commodity and a rental procedure transition button for making a transition to a screen for renting each commodity and displays a price for each case. The link generated in step S125 is set to the rental procedure transition button.

In step S212, when the user depresses the rental procedure transition button by operating the operation acceptance unit 130, the input operation acceptance unit 181 of the terminal apparatus 10 accepts instruction information indicating that the rental procedure transition button (the link generated in step S125) has been depressed with respect to a commodity which the user had selected from the information on the list of commodities and which the user desires to rent. The transmission/reception unit 182 transmits information on the depressed link to the server 20. The transmission/reception unit 182 of the terminal apparatus 10 accepts detailed information on the commodity transmitted from the server 20. The notification control unit 184 causes the display 132 to display the accepted information on the list of commodities.

In step S222, the server 20 accepts, via the communication unit 201, information on the link having been transmitted from the terminal apparatus 10. In response to the request from the terminal apparatus 10, the server 20 replies to the terminal apparatus 10, via the communication unit 201, information on the commodity in order to present detailed information on the commodity by referring to the rental commodity database 282. The detailed information on the commodity transmitted by the server 20 is a screen for accepting the rental instruction generated in step S123 and includes a link for accepting an application instruction from the user and a rental application button.

In step S213, when the user depresses the rental application button by operating the operation acceptance unit 130, the input operation acceptance unit 181 of the terminal apparatus 10 accepts, from the user, instruction information indicating that the rental application button (a button for issuing an instruction for a rental application generated in step S123) has been depressed with respect to a commodity which the user desires to rent. The transmission/reception unit 182 transmits information on the instruction for a rental application to the server 20 based on the depressed rental application button.

In step S223, the rental application acceptance module 2034 of the server 20 accepts, via the communication unit 201, information on the instruction for a rental application with respect to the commodity which has been transmitted from the terminal apparatus 10 and which the user desires to rent.

In step S224, the commodity purchase module 2035 of the server 20 refers to the rental commodity inventory database 283 with respect to the commodity which has been transmitted from the terminal apparatus 10 and which the user desires to rent, and determines whether or not the commodity is present in an inventory managed by the rental business operator. When the commodity is in stock (in a case of “Y” in step S224), the processing advances to step S226, but when the commodity is out of stock (in a case of “N” in step S224), the processing advances to step S225.

In step S225, the commodity purchase module 2035 of the server 20 performs, with respect to the commodity which has been transmitted from the terminal apparatus 10 and which the user desires to rent, processing of purchasing the commodity from an EC site provided by the external server 30. The commodity purchase module 2035 transmits purchase information of the commodity to the external server 30 via the communication unit 201.

In step S235, the external server 30 accepts the purchase information of the commodity transmitted from the server 20.

In step S236, the external server 30 performs purchase processing of the commodity related to the accepted purchase information. Specifically, payment processing related to purchase of the commodity with respect to the rental business operator and shipment processing of the commodity are performed. Note that processing may be performed so that the commodity is directly sent to the user from the dealer operating the external server 30, in which case processing of step S226 being subsequent processing may be skipped.

In step S226, the purchased product management module 2036 of the server 20 performs, with respect to the commodity which has been transmitted from the terminal apparatus 10 and which the user desires to rent, acceptance processing of the commodity when the commodity is purchased from the dealer. In addition, shipment processing to the user is performed with respect to the commodity and a notification to the effect that the commodity has been shipped is transmitted to the terminal apparatus 10.

In step S216, the transmission/reception unit 182 of the terminal apparatus 10 accepts the notification to the effect that the commodity has been shipped having been transmitted from the server 20. Subsequently, the commodity which the user of the terminal apparatus 10 desires to rent is delivered to the user.

In step S227, the purchased product management module 2036 of the server 20 performs processing of managing the commodity as a rental object of the rental service when the commodity is purchased from the dealer. Specifically, management information of the purchased commodity is stored in the rental commodity inventory database 283.

When a rental period of a certain period of time or longer elapses after a commodity is rented to a user, a recommendation may be made to the user of the terminal apparatus 10 for buying out the commodity. For example, when a rental fee is a predetermined monthly amount, a total rental amount is to exceed an amount in a case where the commodity had been purchased outright once a certain period of time elapses. The recommendation is made because, in such a case, having the user buy out the commodity prevents the user from incurring any further rental fees. Providing such a service enables a user to rent the commodity for a certain period of time for the purpose of trying out the commodity and buying out the commodity if the user likes it.

As described above, when a user desires to rent a commodity by using a rental service of the rental service system 1 but the commodity is out of stock, the rental business operator purchases the commodity from a dealer and the commodity is to be managed as a rental object of the rental service. Accordingly, since the commodity is not purchased when there is no one who desires to rent the commodity, the rental business operator need no longer manage extra inventory.

In addition, even when a user desires to rent the commodity, since the rental business operator purchases the commodity from a dealer, there is a benefit to the dealer as well.

<4 Screen Example>

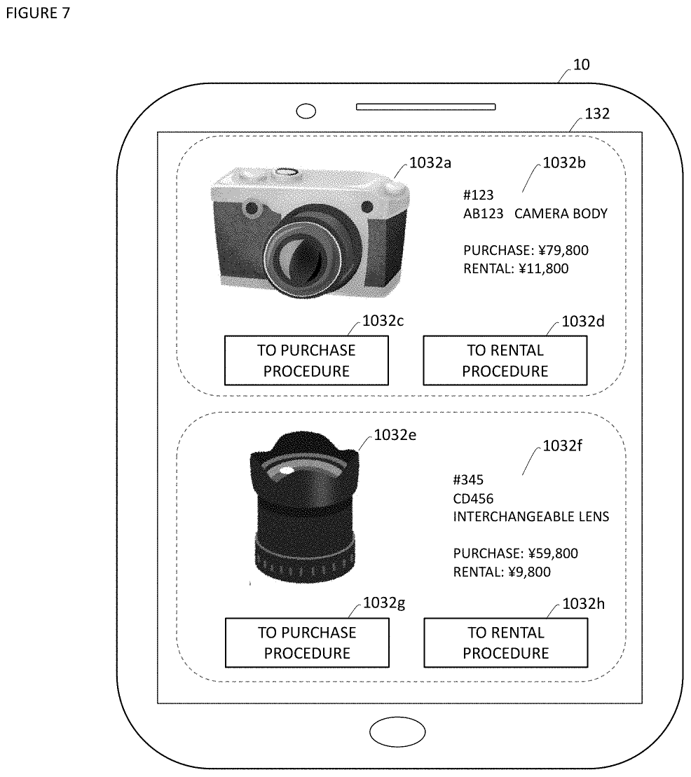

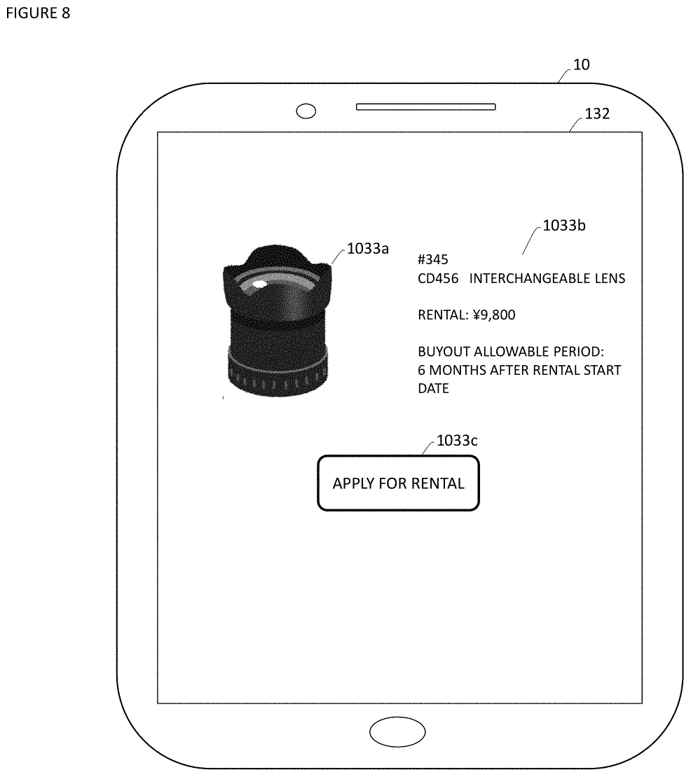

Hereinafter, with reference to FIGS. 7 and 8, screen examples of rental acceptance processing of a commodity for rent by the rental service system 1 will be described.

FIG. 7 is a diagram showing a screen example of the terminal apparatus 10 in the rental acceptance processing of a commodity for rent. The screen example shown in FIG. 7 is a screen example of a state where information on a list of rentable commodities is displayed on the terminal apparatus 10 of a user and represents an example of a case where a “camera body” of which the item “commodity ID” is “#123” and an “interchangeable lens” of which the item “commodity ID” is “#345” stored in the rental commodity database 282 shown in FIG. 4 are displayed. This corresponds to step S211 in FIG. 6.

As shown in FIG. 7, the display 132 of the terminal apparatus 10 displays commodity photographs 1032a and 1032e indicating external appearances of commodities, commodity information display sections 1032b and 1032f which display information such as a commodity ID, a commodity name, a model number, and a price, purchase procedure transition buttons 1032c and 1032g for making a transition to a screen for purchasing the commodities, and rental procedure transition buttons 1032d and 1032h for making a transition to a screen for renting the commodities.

In the example shown in FIG. 7, the commodity information display sections 1032b and 1032f display, side by side, a price when the commodity is to be purchased and a price when the commodity is to be rented. In addition, a user can make a transition to each procedure by depressing the purchase procedure transition buttons 1032c and 1032g when purchasing the commodities and by depressing the rental procedure transition buttons 1032d and 1032h when renting the commodities. Accordingly, both prices of purchasing and renting the commodities can be considered and a transition can be readily made to each of the procedures.

FIG. 8 is a diagram showing a screen example of the terminal apparatus 10 in the rental acceptance processing of a commodity for rent. The screen example shown in FIG. 8 is a screen example of a state where detailed information on a commodity (an interchangeable lens) which the user desires to rent is displayed after the rental procedure transition button 1032h is depressed in the screen example shown in FIG. 7 and represents an example of a case where an “interchangeable lens” of which the item “commodity ID” is “#345” stored in the rental commodity database 282 shown in FIG. 4 is displayed. This corresponds to step S212 in FIG. 6.

As shown in FIG. 8, the display 132 of the terminal apparatus 10 displays a commodity photograph 1033a indicating an external appearance of the commodity, a commodity information display section 1033b which displays detailed information on the commodity, and a rental application button 1033c for issuing a rental instruction for the commodity.

The screen example shown in FIG. 7 is a list of commodities for sale and commodities for rent provided on the external server 30 by a dealer of the commodities and the screen example shown in FIG. 8 is information on a commodity for rent provided on the server 20 by a rental business operator. When renting the commodity, processing from rental application processing to shipment processing is performed by depressing the rental application button 1033c. Accordingly, after considering both prices of purchasing and renting the commodity, a rental application can be readily made.

Note that the commodity information display section 1033b shown in FIG. 8 displays information on a buyout allowable period. As described earlier, this represents a state where, after a commodity has been rented to a user, a recommendation of a buyout allowable period from or after a rental start date is made to the user of the terminal apparatus 10 for buying out the commodity. For example, the display may be performed only when the commodity is out of stock at the rental business operator (a case of “N” in step S224 shown in FIG. 7). In other words, when the user considers whether to purchase or to rent the commodity, the user can rent a brand new commodity in stock at a dealer for a certain period of time and buy out the commodity when the user likes it. Accordingly, usage is enabled such that the commodity is tried out and a state similar to purchasing the commodity outright is created by buying out the commodity when the user likes it but the rented commodity is returned when the user does not like it.

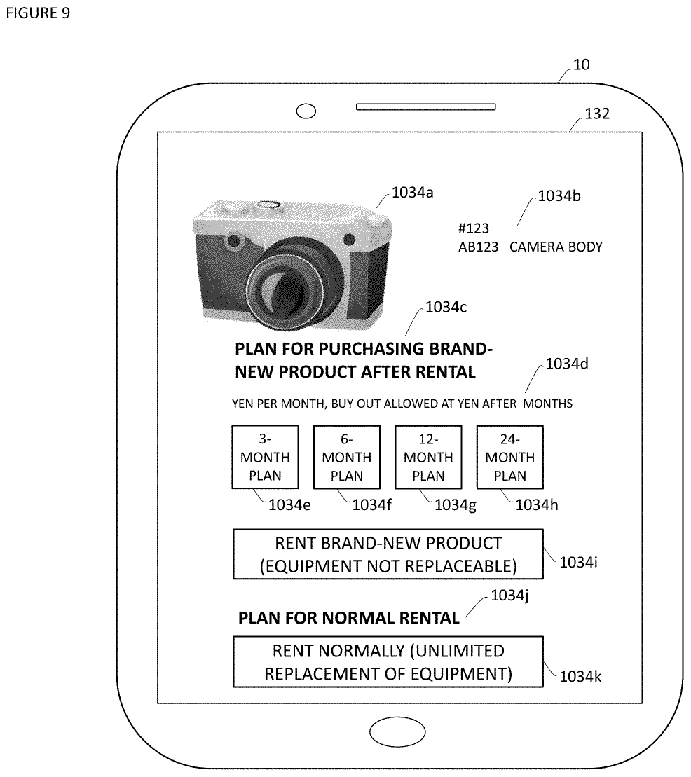

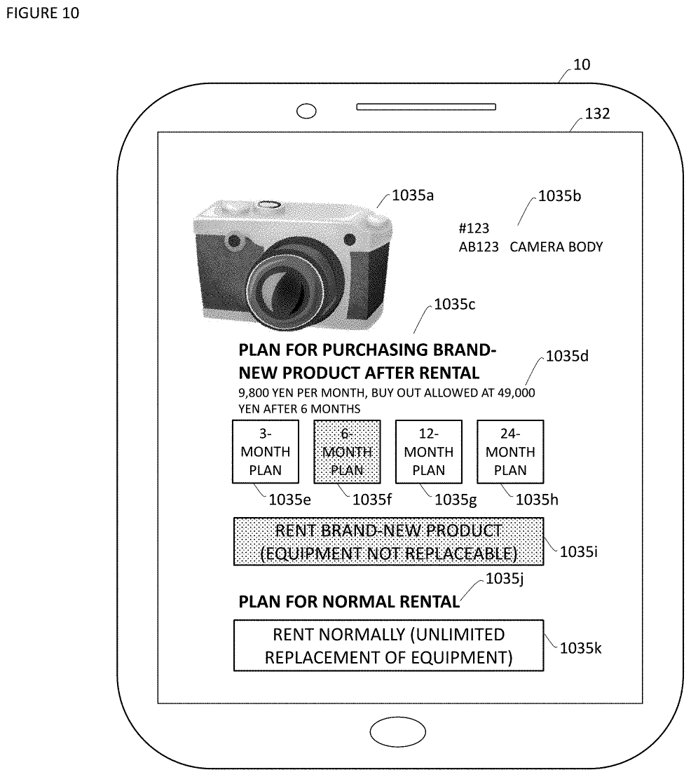

Hereinafter, with reference to FIGS. 9 and 10, other screen examples of rental acceptance processing of a commodity for rent by the rental service system 1 will be described. In this screen example, a case will be described in which, when a brand new commodity of a dealer can be rented for a certain period of time and the commodity can be bought out when a user likes it (a buyout plan), a monthly rental price and a buyout price after the certain period of time elapses are presented by selecting a rentable period and an optimal rentable period desired by the user can be selected.

FIG. 9 is a diagram showing another screen example of the terminal apparatus 10 in the rental acceptance processing of a commodity for rent. The screen example shown in FIG. 9 is a screen example of a state where detailed information on a commodity (a camera body) which the user desires to rent is displayed after the rental procedure transition button 1032h is depressed in the screen example shown in FIG. 7 and represents an example of a case where a “camera body” of which the item “commodity ID” is “#123” stored in the rental commodity database 282 shown in FIG. 4 is displayed. This corresponds to step S212 in FIG. 6.

As shown in FIG. 9, the display 132 of the terminal apparatus 10 displays a commodity photograph 1034a indicating an external appearance of a commodity, a commodity information display section 1034b which displays detailed information on the commodity, a buyout plan introduction section 1034c for renting the commodity for a certain period of time and buying out the commodity when liked, a price presentation section 1034d which presents a monthly rental price and a buyout price after the certain period of time elapses, period selection buttons 1034e, 1034f, 1034g, and 1034h for selecting a rentable period, a buyout plan application button 1034i for applying for a buyout plan after selecting the period selection buttons 1034e to 1034h, a normal plan introduction section 1034j for a plan (a normal plan) of normally renting the commodity, and a normal plan application button 1034k for applying for the normal plan. In this case, the normal plan refers to a plan which, by regularly paying a predetermined amount, the user can borrow a desired commodity (equipment) among a plurality of commodities and can also replace the commodity. For example, the server 20 operates an “all-you-can-rent” service of commodities. In this case, in the normal plan, a plurality of stages are prepared as price plans (for example, a plurality of stages such as seven stages from rank “1” to rank “7”) and the fee to be regularly paid by the user and a range of commodities that can be borrowed differ according to rank. For example, a plan with a high rank may enable all commodities provided in plans with lower ranks to be borrowed. The user can borrow a certain number of commodities and also replace the commodities within a range of commodities that can be borrowed in a contracted price plan.

The screen example shown in FIG. 9 enables a buyout plan shown in the buyout plan introduction section 1034c or a normal plan shown in the normal plan introduction section 1034j to be selected. Since the buyout plan is premised on buying out a rented commodity after a certain period of time elapses, the rented commodity cannot be replaced (renewed), whereas the rented commodity can be replaced in the normal plan. Information to that effect is shown on the buyout plan application button 1034i and the normal plan application button 1034k. However, the buyout plan is configured such that a rented commodity can be returned up to the lapse of a certain period of time. A single screen is configured so as to enable the buyout plan or the normal plan to be selected in this manner in order to enable contents of the buyout plan and contents of the normal plan to be contrasted with each other and selected.

In the screen example shown in FIG. 9, the camera body displayed in the commodity photograph 1034a can be rented and used for a certain period of time and can be bought out if the camera body is liked. This is due to the fact that, since functions, performance, and usability of a commodity cannot be known unless the commodity is actually used, the rental period is used as a trial period for trying out the commodity. First, on the screen, a rental period (a trial period) is selected from the period selection buttons 1034e to 1034h. The period selection buttons 1034e to 1034h are configured so that anyone can be selected, and by selecting any one button by clicking on or tapping on the same, a color of the selected button changes to enable recognition that the button is in a selected state. In the screen example shown in FIG. 9, the period selection button 1034e is a button for selecting 3 months as the rental period, the period selection button 1034f is a button for selecting 6 months as the rental period, the period selection button 1034g is a button for selecting 12 months as the rental period, and the period selection button 1034h is a button for selecting 24 months as the rental period. Rental periods are made selectable in this manner because a period for a tryout differs from one user to the next and presenting a plurality of periods increases convenience of users.

Note that the buyout plan application button 1034i is configured such that the button cannot be depressed (for example, displayed in a light gray color indicating a state where the button cannot be depressed) unless any one of the period selection buttons 1034e to 1034h is selected and that, once any one of the period selection buttons 1034e to 1034h is selected, the color of the buyout plan application button 1034i changes and the button becomes depressible.

FIG. 10 is a diagram showing another screen example of the terminal apparatus 10 in the rental acceptance processing of a commodity for rent. The screen example shown in FIG. 10 is an example of a case where the user has selected the period selection button 1034f which represents 6 months as the rental period in the screen example shown in FIG. 9. This corresponds to step S212 in FIG. 6.

As shown in FIG. 10, the display 132 of the terminal apparatus 10 displays a commodity photograph 1035a, a commodity information display section 1035b, a buyout plan introduction section 1035c, a price presentation section 1035d, period selection buttons 1035e to 1035h, a buyout plan application button 1035i, a normal plan introduction section 1035j, and a normal plan application button 1035k which are similar to the screen configuration shown in FIG. 9.

When the user selects the period selection button 1035f in the screen example shown in FIG. 9, a color of the period selection button 1035f changes, a color of the buyout plan application button 1035i also changes, and the buyout plan application button 1035i becomes depressible as shown in FIG. 10. In addition, at this point, a monthly rental price and a buyout price after a lapse of 6 months when 6 months is selected as the rental period are displayed in the price presentation section 1035d. In this state, the period selection buttons 1035e, 1035g, and 1035h representing other periods can also be selected, and once any of the buttons is selected, displayed contents of the price presentation section 1035d change in accordance with the selected period. For example, in a state where display contents of the price presentation section 1035d shown in FIG. 10 are “9,800 yen per month Available for buyout for 49,000 after 6 months” representing a rental period of 6 months, when the user reselects the period selection button 1035g representing 12 months as the rental period, the display contents are changed to “7,800 yen per month Available for buyout for 29,000 after 12 months” representing a rental period of 12 months. Accordingly, a selection can be made after assessing a monthly rental fee and a buyout price after a lapse of the rental period of each period.

Note that a configuration is adopted in which a color in a state where any one of the period selection buttons 1035e to 1035h shown in FIG. 10 is selected and the color of the buyout plan application button 1035i are the same color which differs from the color of the normal plan application button 1035k. This is done to prevent incorrect operations and to enable recognition that the buyout plan and the normal plan are different plans.

<Summary>

As described above, according to the present embodiment, a product (commodity) page of an EC site of a dealer displays a link when the commodity is to be rented, and by making a transition from the link, an instruction for a rental application for the commodity is issued. Accordingly, both prices when purchasing and renting the commodity can be considered. In addition, once the rental application for the commodity is accepted, the commodity is purchased and managed as a rental object of a rental service. Accordingly, a system can be constructed which is advantageous for the dealer and also advantageous for a rental business operator since an inventory need not be managed until a rental application is made.

### Second Embodiment

Hereinafter, a rental service system 1 for providing a service that rents commodities such as a camera and an interchangeable lens will be described.

<1 Overall Configuration of Rental Service System 1>

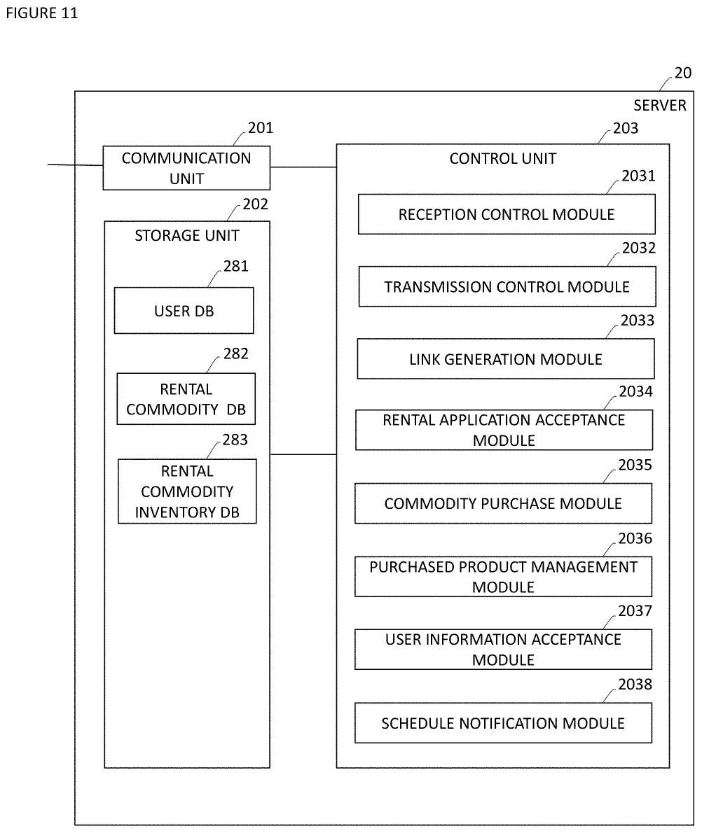

FIG. 11 is a diagram showing a functional configuration of the server 20 constituting the rental service system 1 according to a second embodiment. Since an overall configuration of the rental service system 1 and a configuration of the terminal apparatus 10 according to the second embodiment are similar to those in the first embodiment, no repetitive descriptions will be given. As shown in FIG. 11, a configuration of the server 20 is similar to that in the first embodiment with the exception of the server 20 newly including functions of a user information acceptance module 2037 and a schedule notification module 2038. Hereinafter, functions of the user information acceptance module 2037 and the schedule notification module 2038 according to the second embodiment will be described.

The user information acceptance module 2037 controls, in a case where a commodity for which a user has made a rental application is out of stock, processing of accepting information on the user from the external server 30 when purchasing the commodity from an EC site provided by the external server 30. While the information on the user to be accepted from the external server 30 is a name of the user, attribute information of the user, and the like, the information may also include history information on commodities purchased by the user from the EC site provided by the external server 30 and history information on commodities viewed by the user on the EC site. The user information acceptance module 2037 stores the accepted information on the user in the user database 281 as information on a user of a rental service. The purchase history information and the viewing history information included in the user information may be used when presenting the user with a recommendation of a rental commodity.

In addition, when directly sending the commodity to the user from a dealer operating the external server 30, the user information acceptance module 2037 may accept shipment information when the dealer ships the commodity as information on the user. Shipment information is, for example, a slip number of a delivery company that delivers the commodity or information on an estimated arrival date/time.

The schedule notification module 2038 controls, when directly sending the commodity to the user from the dealer operating the external server 30 and accepting shipment information when the dealer ships the commodity as information on the user, processing of notifying the terminal apparatus 10 of the shipment information.

<2 Data Structure>

Since a data structure according to the second embodiment is similar to that in the first embodiment, no repetitive descriptions will be given.

<3 Operations>

Hereinafter, with reference to FIG. 6, processing which differs from that of the first embodiment among rental acceptance processing of a commodity for rent by the rental service system 1 according to the second embodiment will be described.

In step S236 shown in FIG. 6, the external server 30 performs purchase processing of a commodity related to the accepted purchase information, and when performing shipment processing of the commodity, the external server 30 accepts information on the user including a name of the user, attribute information of the user, purchase history information and viewing history information of the user on an EC site, and shipment information when a dealer had shipped the commodity.

In step S226, the user information acceptance module 2037 of the server 20 accepts the information on the user transmitted from the external server 30. In addition, the user information acceptance module 2037 stores the accepted information on the user in the user database 281 as information on a user of a rental service.

In addition, in step S226, the schedule notification module 2038 of the server 20 notifies the terminal apparatus 10 of shipment information when the dealer had shipped the commodity as information on the user.

In step S216, the transmission/reception unit 182 of the terminal apparatus 10 accepts the notification of the shipment information transmitted from the server 20. Subsequently, the terminal apparatus 10 causes the display 132 to display the shipment information to the user.

As described above, information on the user is accepted from the external server 30 and the information on the user is registered as information on a user of a rental service. In addition, shipment information when a dealer had shipped a commodity is accepted as information on the user and notified to the terminal apparatus 10. Accordingly, the hassle of having the user input information can be reduced and a shipment status of a commodity to be rented can be notified.

<Summary>

As described above, according to the present embodiment, information on the user is accepted from an external website and registered as information on a user of a rental service. Accordingly, the hassle of having the user input information can be reduced. In addition, history information of commodities purchased from an EC site and history information of commodities viewed on the EC site are also registered as information on the user. Accordingly, based on the pieces of history information of the user, the user can be provided with recommendation information that is conducive to service. Furthermore, shipment information when a dealer had shipped a commodity is accepted as information on the user and notified to the terminal apparatus 10. Accordingly, since the user can grasp a status of a commodity for which the user had made a rental application, service to the user can be improved.

### Third Embodiment

Hereinafter, a rental service system 1 for providing a service that rents commodities such as a camera and an interchangeable lens will be described.

<1 Overall Configuration of Rental Service System 1>

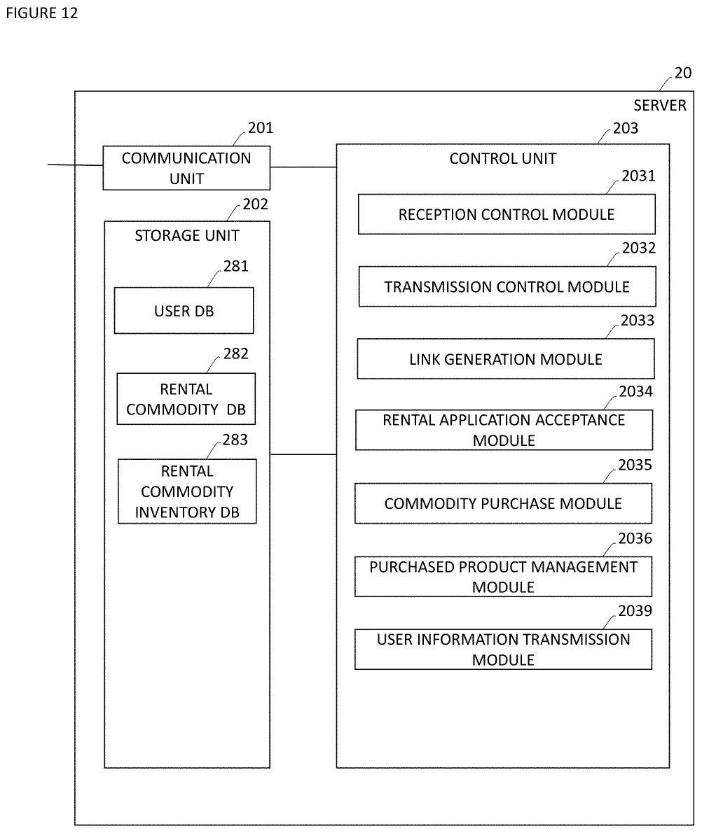

FIG. 12 is a diagram showing a functional configuration of the server 20 constituting the rental service system 1 according to a third embodiment. Since an overall configuration of the rental service system 1 and a configuration of the terminal apparatus 10 according to the third embodiment are similar to those in the first embodiment, no repetitive descriptions will be given. As shown in FIG. 12, a configuration of the server 20 is similar to that in the first embodiment with the exception of the server 20 newly including functions of a user information transmission module 2039. Hereinafter, functions of the user information transmission module 2039 according to the third embodiment will be described.

The user information transmission module 2039 controls processing of transmitting information on a user stored in the user database 281 to the external server 30 in order to share the information on the user with the external server 30. A timing of transmitting the information on the user may be when the user depresses a rental procedure transition button (when the user accesses first information) or when the user depresses a rental application button (when the user issues a first instruction). In addition, when transmitting the information on the user to the external server 30, information on a privilege offered based on the user's use of the rental service such as points exchangeable for predetermined products or the like may be transmitted as the information on the user.

In addition, the information on the user to be transmitted to the external server 30 may be information on a user having rented a commodity such as a length of a subsequent rental period of the commodity or whether or not the user had used the buyout service described earlier. For a dealer operating the external server 30 having acquired such information, since it is conceivable that the commodity (product) is of inferior quality if the rental period is short and the buyout service had not been used, the dealer can reconsider the quality of the product. Furthermore, when the buyout service had been used, it is conceivable that certain quality is ensured. In this manner, sharing information after rental contributes to decision-making by the dealer when selecting products to be purchased.

Furthermore, when a user having rented a commodity subsequently returns the commodity, a questionnaire regarding a reason for return may be acquired and information on the questionnaire may be shared. By acquiring such questionnaire information, a reason as to why the commodity had not been purchased from the dealer can be obtained such as the commodity had not been purchased but rented because the commodity was only going to be temporarily used. Sharing such information contributes to decision-making by the dealer when selecting a purchase time or a quantity of products to be purchased.

<2 Data Structure>

Since a data structure according to the second embodiment is similar to that in the first embodiment, no repetitive descriptions will be given.

<3 Operations>

Hereinafter, with reference to FIG. 6, processing which differs from that of the first embodiment among rental acceptance processing of a commodity for rent by the rental service system 1 according to the second embodiment will be described.

In step S222 shown in FIG. 6, when a rental procedure transition button is depressed by a user, the user information transmission module 2039 of the server 20 transmits information on the user to the external server 30. The external server 30 may accept the information on the user and use the information as, for example, sales promotion information. Note that this processing may be performed in step S223 shown in FIG. 6 when the user depresses a rental application button.

As described above, information on the user is transmitted from the server 20 to the external server 30 and shared. Accordingly, convenience for the user can be improved.

<Summary>

As described above, according to the present embodiment, information on the user is transmitted to and shared by an external website. Accordingly, since sales promotion information and privilege information with respect to the user are to be shared, convenience for the user can be improved.

While embodiments of the disclosure have been described, it is to be understood that the disclosure can be carried out in various other modes and that various omissions, substitutions, and changes can be made thereto. The technical scope of the appended claims and their equivalents are intended to cover such embodiments, modifications, and modes reflecting omissions, substitutions, and changes as fall within the scope and spirit of the invention.

<Supplement>

Matters described in the respective embodiments above will be supplemented below.

(Supplementary item 1) An information processing apparatus, including: a control unit; and a storage unit, the information processing apparatus being configured to provide a user with a rental service of commodities, wherein the storage unit is configured to store information for specifying each commodity, and the control unit performs: a step of generating first information for accepting, from a user, an instruction of a rental application for a commodity for rent on an external website; a step of causing, in response to an access from a terminal of the user to the external website, the terminal of the user to display a screen for accepting a first instruction to perform a rental application for the commodity for rent based on the first information; a step of performing, in response to accepting the first instruction from the user, processing for purchasing a commodity related to the first instruction; and a step of performing processing for managing the purchased commodity as a rental object of the rental service.

(Supplementary item 2) The information processing apparatus according to (Supplementary item 1), wherein the control unit causes, in response to the user accessing the first information, the terminal of the user to display a screen for accepting the first instruction.

(Supplementary item 3) The information processing apparatus according to (Supplementary item 2), wherein the control unit causes, when the user selects the first information on a screen of the external website on which the first information is displayed, the terminal of the user to display a screen for accepting the first instruction as a screen of the external website.

(Supplementary item 4) The information processing apparatus according to (Supplementary item 2), wherein the control unit generates link information indicating a website that differs from the external website as the first information, and causes, when the user selects the link information on a screen of the external website on which the link information is displayed, the terminal of the user to display a screen for accepting the first instruction as a screen of the website that differs from the external website.

(Supplementary item 5) The information processing apparatus according to (Supplementary item 4), wherein on a screen for accepting the first instruction, after a commodity for rent of the rental service is rented out, information for buying out the commodity is caused to be displayed.

(Supplementary item 6) The information processing apparatus according to any one of (Supplementary item 1) to (Supplementary item 5), wherein the control unit performs, when accepting the first instruction from the user, a step of accepting information on the user transmitted from the external website and registering the accepted information as information on a user of the rental service.

(Supplementary item 7) The information processing apparatus according to (Supplementary item 6), wherein information including purchase information or viewing information of the user on the external website is accepted as information on the user.

(Supplementary item 8) The information processing apparatus according to (Supplementary item 6) or (Supplementary item 7), wherein sending information when a commodity for rent in the rental service is sent to the user from the external website is accepted as information on the user.

(Supplementary item 9) The information processing apparatus according to (Supplementary item 8), wherein the control unit performs a step of presenting the user with schedule information which is included in the sending information and according to which the commodity is to be delivered to the user.

(Supplementary item 10) The information processing apparatus according to any one of (Supplementary item 1) to (Supplementary item 9), wherein the control unit performs a step of transmitting, to the external website, information on a user of the rental service in order to share the information with the external website.

(Supplementary item 11) The information processing apparatus according to (Supplementary item 10), wherein a step of transmitting, to the external website, when the user accesses the first information or when the first instruction is accepted from the user, information on a user of the rental service in order to share the information with the external website is performed.

(Supplementary item 12) The information processing apparatus according to (Supplementary item 10) or (Supplementary item 11), wherein privilege information to the user with respect to use of the rental service is transmitted to the external website for the external website.

(Supplementary item 13) A method which is executed by a computer including a processor and which is for providing a user with a rental service of commodities, wherein the processor executes: a step of generating first information for accepting, from a user, an instruction of a rental application for a commodity for rent on an external website; a step of causing, in response to an access from a terminal of the user to the external website, the terminal of the user to display a screen for accepting a first instruction to perform a rental application for the commodity for rent based on the first information; a step of performing, in response to accepting the first instruction from the user, processing for purchasing a commodity related to the first instruction; and a step of performing processing for managing the purchased commodity as a rental object of the rental service.

(Supplementary item 14) A program which is executed by a computer including a processor and which is for providing a user with a rental service of commodities, the program causing the processor to execute: a step of generating first information for accepting, from a user, an instruction of a rental application for a commodity for rent on an external website; a step of causing, in response to an access from a terminal of the user to the external website, the terminal of the user to display a screen for accepting a first instruction to perform a rental application for the commodity for rent based on the first information; a step of performing, in response to accepting the first instruction from the user, processing for purchasing a commodity related to the first instruction; and a step of performing processing for managing the purchased commodity as a rental object of the rental service.

### REFERENCE SIGNS LIST

10 Terminal apparatus
20 Server
30 External server
80 Network
130 Operation acceptance unit (touch screen)
171 User information
22 Communication IF
23 Input/output IF
25 Memory
26 Storage
29 Processor
201 Communication unit
202 Storage unit
281 User database
282 Rental commodity database
283 Rental commodity inventory database
203 Control unit

1. An information processing apparatus, comprising:
a processing circuitry and a storage unit,
the information processing apparatus being configured to provide a user with a rental service of commodities, wherein
the storage unit is configured to store information for specifying each commodity, and
the processing circuitry performs:
a step of generating first information for accepting, from a user, an instruction of a rental application for a commodity for rent on an external website;
a step of causing, in response to an access from a terminal of the user to the external website, the terminal of the user to display a screen for accepting a first instruction to perform a rental application for the commodity for rent based on the first information;
a step of performing, in response to accepting the first instruction from the user, processing for purchasing a commodity related to the first instruction; and
a step of performing processing for managing the purchased commodity as a rental object of the rental service.

2. The information processing apparatus according to claim 1, wherein
the processing circuitry
causes, in response to the user accessing the first information, the terminal of the user to display a screen for accepting the first instruction.

3. The information processing apparatus according to claim 2, wherein
the processing circuitry
causes, when the user selects the first information on a screen of the external website on which the first information is displayed, the terminal of the user to display a screen for accepting the first instruction as a screen of the external website.

4. The information processing apparatus according to claim 2, wherein
the processing circuitry
generates link information indicating a website that differs from the external website as the first information, and
causes, when the user selects the link information on a screen of the external website on which the link information is displayed, the terminal of the user to display a screen for accepting the first instruction as a screen of the website that differs from the external website.

5. The information processing apparatus according to claim 4, wherein
on a screen for accepting the first instruction, after a commodity for rent of the rental service is rented out, information for buying out the commodity is caused to be displayed.

6. The information processing apparatus according to claim 5, wherein
the processing circuitry performs, when accepting the first instruction from the user, a step of accepting information on the user transmitted from the external website and registering the accepted information as information on a user of the rental service.

7. The information processing apparatus according to claim 6, wherein
information including purchase information or viewing information of the user on the external website is accepted as information on the user.

8. The information processing apparatus according to claim 7, wherein
sending information when a commodity for rent in the rental service is sent to the user from the external website is accepted as information on the user.

9. The information processing apparatus according to claim 8, wherein
the processing circuitry
performs a step of presenting the user with schedule information which is included in the sending information and according to which the commodity is to be delivered to the user.

10. The information processing apparatus according to claim 9, wherein
the processing circuitry
performs a step of transmitting, to the external website, information on a user of the rental service in order to share the information with the external website.

11. The information processing apparatus according to claim 10, wherein
a step of transmitting, to the external website, when the user accesses the first information or when the first instruction is accepted from the user, information on a user of the rental service in order to share the information with the external website is performed.

12. The information processing apparatus according to claim 10, wherein
privilege information to the user with respect to use of the rental service is transmitted to the external website for the external website.

13. A method which is executed by a computer including a processor and which is for providing a user with a rental service of commodities, wherein
the processor executes:
a step of generating first information for accepting, from a user, an instruction of a rental application for a commodity for rent on an external website;
a step of causing, in response to an access from a terminal of the user to the external website, the terminal of the user to display a screen for accepting a first instruction to perform a rental application for the commodity for rent based on the first information;
a step of performing, in response to accepting the first instruction from the user, processing for purchasing a commodity related to the first instruction; and
a step of performing processing for managing the purchased commodity as a rental object of the rental service.

14. A nonvolatile storage medium that stores a program which is executed by a computer including a processor and which is for providing a user with a rental service of commodities,
the program causing the processor to execute:
a step of generating first information for accepting, from a user, an instruction of a rental application for a commodity for rent on an external website;
a step of causing, in response to an access from a terminal of the user to the external website, the terminal of the user to display a screen for accepting a first instruction to perform a rental application for the commodity for rent based on the first information;
a step of performing, in response to accepting the first instruction from the user, processing for purchasing a commodity related to the first instruction; and
a step of performing processing for managing the purchased commodity as a rental object of the rental service.
